(19) United States
(12) Patent Application Publication
(10) Pub. No.: US 2009/0039948 A1
(43) Pub. Date: Feb. 12, 2009

(54) CHARGE PUMP CIRCUIT AND CHARGE PUMPING METHOD THEREOF

(76) Inventors: JUNG HWAN PARK, Yongin-si (KR); IN-CHUL JEONG, Suwon-si (KR)

Correspondence Address: F. CHAU & ASSOCIATES, LLC, 130 WOODBURY ROAD, WOODBURY, NY, 11797, US

(21) Appl. No.: 12/187,292

(22) Filed: Aug. 6, 2008

(30) Foreign Application Priority Data
Aug. 7, 2007 (KR) 10-2007-78993

(51) Int. Cl. G05F 3/02

(52) U.S. Cl. 327/536

(57) ABSTRACT

A charge pump circuit includes first and second charge pumps and a detector. The first charge pump outputs a first charge pump signal of an intermediate voltage level by performing a charge pumping operation in response to a command signal. The detector outputs a detection signal in response to the command signal when a voltage level of an output node is lower than a designated voltage voltage. The second charge pump charge-pumps the voltage level of the output node to a target charge-pumped voltage level higher than the intermediate voltage level and the designated voltage in response to the detection signal and the first charge pump signal.

### CROSS-REFERENCE TO RELATED APPLICATION

This application claims the benefit of Korean Patent Application No. 2007-0078993, filed Aug. 7, 2007, the disclosure of which is incorporated by reference herein.

### BACKGROUND OF THE INVENTION

1. Technical Field

The present disclosure relates to a charge pump circuit and a charge pumping method, and more particularly, to a charge pump circuit and a charge pumping method that reduces a charge pumping time.

2. Discussion of the Related Art

As technology develops, various electronic products are becoming miniaturized. With this trend, the need exists for semiconductor devices operating on a single power supply and on a low-voltage. However, depending on the type of semiconductor device, a circuit may require a higher voltage than the one provided by an external power supply. Accordingly, a charge pump circuit capable of generating a high voltage in the semiconductor device is desired. The charge pump circuit is used to generate a higher voltage than the power supply voltage applied to the semiconductor device.

### SUMMARY OF THE INVENTION

Embodiments of the present invention seek to provide a charge pump circuit that raises an operating speed by generating a first charge pump signal in response to a command signal before a detection signal is activated.

A charge pump circuit, according to an exemplary embodiment of the present invention, includes a first charge pump for outputting a first charge pump signal of an intermediate voltage level in response to a command signal; a detector for outputting a detection signal in response to the command signal when a voltage level of an output node is lower than a designated voltage; and a second charge pump for charge-pumping the voltage level of the output node to a target charge-pumped voltage level higher than the intermediate voltage level and the designated voltage in response to the detection signal and the first charge pump signal.

The first charge pump may include at least one charge pump circuit for performing a charge pumping operation in response to the command signal.

The second charge pump may include a transfer determiner for outputting a second charge pump signal for activating the second charge pump in response to the detection signal and the first charge pump signal; a precharge controller for deactivating a precharge control signal in response to the second charge pump signal; a delay unit for outputting a delayed signal by delaying the second charge pump signal for a predetermined time; a transfer controller for outputting a transfer control signal in response to the second charge pump signal; and charge pump circuitry for charge-pumping the voltage level of the output node to the target charge-pumped voltage level.

The charge pump circuitry may include a first transistor connected between a first power supply voltage and a first node and deactivated in response to the precharge control signal, the first transistor precharging the first node; a pump capacitor, connected between the delay unit and the first node, for charge-pumping a voltage level of the first node in response to the delayed signal; and a second transistor for connecting the first node and the output node in response to the transfer control signal.

A charge pumping method, according to an exemplary embodiment of the present invention, includes generating a first charge pump signal of an intermediate voltage level in response to a command signal; detecting a voltage level of an output node in response to the command signal simultaneously with the generation of the first charge pump signal, and outputting a detection signal when a voltage level of the output node is lower than a designated voltage; and charge-pumping the voltage level of the output node in response to the first charge pump signal and the detection signal.

Generating the first charge pump signal may include performing a charge pumping operation in at least one charge pump stage in response to the command signal.

Charge-pumping the voltage level of the output node may include outputting a second charge pump signal to control the charge-pumping of the voltage level of the output node in response to the detection signal and the first charge pump signal; deactivating and outputting a precharge control signal in response to the second charge pump signal; outputting a delayed signal by delaying the second charge pump signal for a predetermined time; outputting a transfer control signal in response to the second charge pump signal; and charge-pumping the voltage level of the output node to a target charge-pumped voltage higher than the intermediate voltage level and the designated voltage in response to the precharge control signal, the delayed signal, and the transfer control signal.

Charge-pumping the voltage level of the output node may include precharging a first node in response to the precharge control signal; charge-pumping a voltage level of the first node in response to the delayed signal; and charge-sharing between the first node and the output node by connecting the charged-pumped first node to the output node.

### BRIEF DESCRIPTION OF THE DRAWINGS

Exemplary embodiments of the present invention will become apparent by reference to the following detailed description taken in conjunction with the accompanying drawings, wherein:

FIG. 1 is a schematic diagram showing a charge pump circuit according to an exemplary embodiment of the present invention; and

FIG. 2 is a timing diagram of the charge pump circuit shown in FIG. 1.

### DETAILED DESCRIPTION OF THE EXEMPLARY EMBODIMENTS

A charge pump circuit and a charge pumping method according to exemplary embodiments of the present invention will be described in detail with reference to the accompanying drawings.

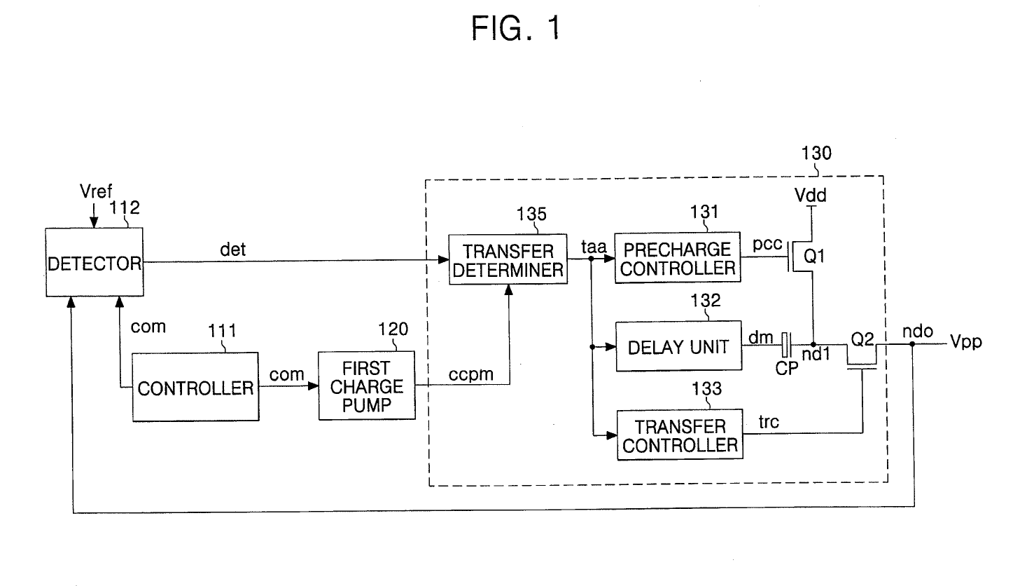

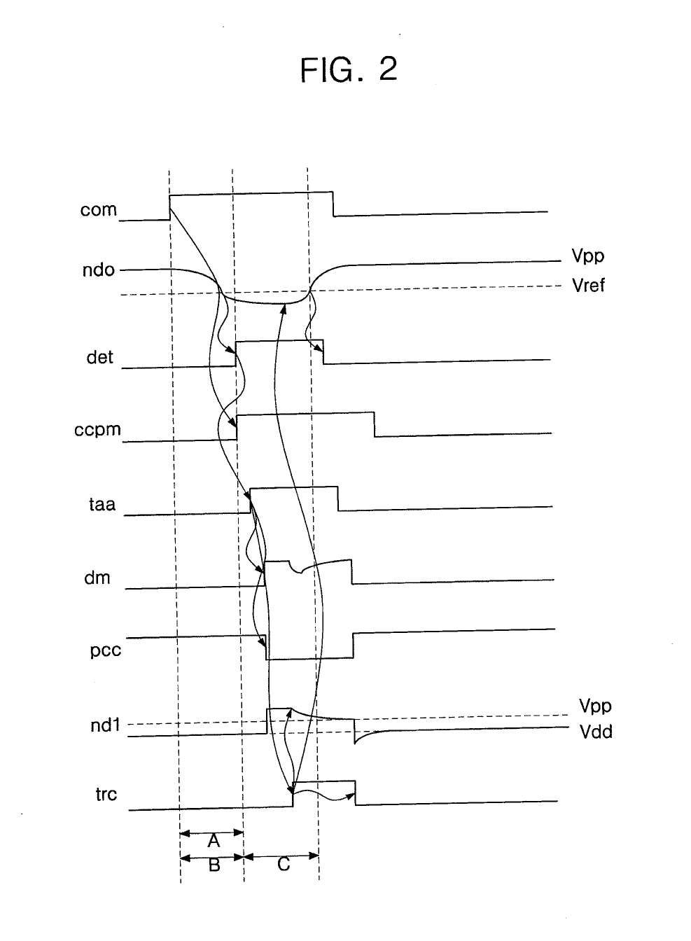

FIG. 1 is a schematic diagram showing a charge pump circuit according to an exemplary embodiment of the present invention, and FIG. 2 is a timing diagram of the charge pump circuit shown in FIG. 1.

In the charge pump circuit of FIG. 1, a controller Ill outputs a command signal com to a detector 112 and a first charge pump 120. In the charge pump circuit of FIG. 1, the first charge pump 120 outputs a first charge pump signal ccpm in response to the command signal com. Accordingly, the first charge pump 120 outputs the first charge pump signal ccpm in response to the command signal com even when the detector 112 does not activate the detection signal det.

The detector 112 detects a voltage level of an output node ndo in response to the command signal com. The detector 112 receives a reference voltage Vref in order to detect the voltage level of the output node ndo. When the voltage level of the output node ndo is lower than the reference voltage Vref, the detector 112 activates the detection signal det.

A last charge pump 130 receives the detection signal det and the first charge pump signal ccpm. A transfer determiner 135 outputs a last charge pump signal taa in response to the detection signal det and the first charge pump signal ccpm. In the charge pump circuit of FIG. 1 the first charge pump 120 activates the first charge pump signal ccpm even when the detection signal det is not activated, such that the last charge pump 130 performs a charge pumping operation when the voltage level of the output node ndo is higher than the reference voltage Vref. To prevent this problem, the transfer determiner 135 outputs the activated last charge pump signal taa when both the first charge pump signal ccpm and the detection signal det are activated. Thus, when the voltage level of the output node ndo is lower than the reference voltage Vref, the voltage level of the output node ndo can be charge-pumped. The transfer determiner 135 may be implemented with a logic gate such as an AND gate.

When the activated first charge pump signal ccpm and the activated detection signal det are applied to the transfer determiner 135, the transfer determiner 135 activates and outputs the last charge pump signal taa. The activated last charge pump signal taa is applied to a precharge controller 131, a delay unit 132, and a transfer controller 133. The last charge pump signal taa is output at the same level as an intermediate voltage level of the first charge pump signal ccpm output from the first charge pump 120.

The precharge controller 131 deactivates a precharge control signal pcc in response to the last charge pump signal taa and outputs the deactivated precharge control signal pcc to a transistor Q1. The transistor Q1 connected between an internal power supply voltage Vdd and a first node nd1 receives the precharge control signal pcc through its gate. When the deactivated last charge pump signal taa is applied, the precharge controller 131 activates the precharge control signal pcc to a high level and activates the transistor Q1. In response to the precharge control signal pcc activated to the high level, the transistor Q1 applies the internal power supply Vdd to the first node nd1. However, since the transistor Q1 is an NMOS transistor, a voltage (Vdd−Vth1) given by subtracting a threshold voltage Vth1 of the transistor Q1 from the internal power supply voltage Vdd is applied to the first node nd1. When the last charge pump signal taa is activated, the precharge control signal pcc is deactivated to the low level. In response to the precharge control signal pcc deactivated to the low level, the transistor Q1 is turned off and the first node nd1 is floated at the first voltage level (Vdd−Vth1) given by subtracting the threshold voltage Vth1 of the transistor Q1 from the internal power supply voltage Vdd.

The delay unit 132 outputs a delayed signal dm to a pump capacitor CP by delaying the last charge pump signal taa for a predetermined time. The delay unit 132 of FIG. 1 outputs the last charge pump signal taa delayed for the predetermined time in order to output the delayed signal dm at substantially the same time as the precharge control signal pcc output from the precharge controller 131. That is, the delay unit 132 outputs the delayed signal dm by delaying the last charge pump signal taa for substantially the same time as is taken to output the precharge control signal pcc from the precharge controller 131 in response to the last charge pump signal taa.

Since the first node nd1 floats at the first voltage level (Vdd−Vth1) because of the precharge control signal pcc, a voltage of the first node nd1 has a second voltage level (Vdd−Vth1+Vdm) given by adding a voltage level Vdm of the delayed signal dm to the first voltage level (Vdd−Vth1) when the delayed signal dm is applied to the pump capacitor CP. Since the last charge pump signal taa has the same voltage level as the first charge pump signal ccpm charge-pumped in the first charge pump 120, the delayed signal dm of the voltage level Vdm is also charge-pumped to the intermediate voltage level. Accordingly, the second voltage level (Vdd−Vth1+Vdm) of the first node nd1 is a high voltage level.

In response to the last charge pump signal taa, the transfer controller 133 activates a transfer control signal trc. The transistor Q2 is turned on in response to the transfer control signal trc, and the voltage of the first node nd1 and the voltage of the output node ndo are charge-shared. The transfer controller 133 activates the transfer control signal trc after the precharge control signal pcc and the delayed signal dm are activated. This is because charge sharing is achieved between the first node nd1 and the output node ndo after the first node nd1 is floated at the first voltage level (Vdd−Vth1) by the precharge control signal pcc, and the voltage level of the first node nd1 is completely charge-pumped to the second voltage level (Vdd−Vth1+Vdm) by the pump capacitor CP.

The voltage level of the output node ndo charge-sharing with the first node nd1 of the second voltage level (Vdd−Vth1+Vdm) is raised to a target charge-pumped voltage Vpp. The target charge-pumped voltage Vpp output from the output node ndo has a higher level than the reference voltage Vref.

The transfer controller 133 activates the transfer control signal trc for a predetermined time such that the charge sharing can be completed between the output node ndo and the first node nd1. After the charge sharing is completed between the output node ndo and the first node nd1, the transfer controller 133 deactivates the transfer control signal trc.

In the charge pump circuit shown in FIG. 1, the first charge pump 120 performs a charge pumping operation in response to the command signal com even when the detector 112 does not activate the detection signal det. When the detection signal det is activated, the last charge pump 130 performs the charge pumping operation to increase the voltage level of the output node ndo to the target charge-pumped voltage Vpp. Therefore, the above-described charge pump circuit has a high operating speed.

As shown in FIG. 2, when the controller 111 outputs the command signal com, the detector 112 detects the voltage level of the output node ndo. The detector 112 outputs the detection signal det of the high level when the voltage level of the output node ndo is lower than the reference voltage Vref.

While the detector 112 detects the voltage level of the output node ndo, the first charge pump 120 activates the first charge pump signal ccpm by performing the charge pumping operation in response to the command signal com.

An example in which the first charge pump 120 activates the first charge pump signal ccpm at the same time as the detector 112 activates the detection signal det has been described with reference to FIG. 2. However, the activation timing of the detection signal det and of the first charge pump signal ccpm typically do not coincide.

The transfer determiner 135 of the last charge pump 130 activates the last charge pump signal taa in response to the detection signal det and the first charge pump signal ccpm. Assuming that the transfer determiner 135 is implemented with a logic AND gate, the last charge pump signal taa of FIG. 2 is output by performing an AND operation on the detection signal det and the first charge pump signal ccpm.

The delay unit 132 outputs the delayed signal dm of the high level by delaying the last charge pump signal taa for the predetermined time, and the precharge controller 131 outputs the precharge control signal pcc of the low level in response to the last charge pump signal taa. When the first node nd1 has been charged to the first voltage level (Vdd−Vth1) by the precharge control signal pcc, the first node nd1 is floats at the first voltage level (Vdd−Vth1) when the precharge control signal pcc is shifted to the low level. When the delayed signal dm is applied to the pump capacitor CP, the voltage level of the first node nd1 floating at the first voltage level (Vdd−Vth1) is charge-pumped to the second voltage level (Vdd−Vth1+Vdm). The transfer controller 133 outputs the transfer control signal trc in response to the last charge pump signal taa, and the second voltage level (Vdd−Vth1+Vdm) of the first node nd1 and the voltage level of the output node ndo are charge-shared, thereby generating the charge-pumped voltage Vpp.

Since the detection interval A and the charge transfer interval B overlap in the charge pumping operation of FIG. 2, they are integrated into one time interval. Accordingly, the charge pumping operation of FIG. 2 reduces the time of the detection interval A.

That is, when the controller 111 activates the command signal com in the charge pump circuit of FIG. 1, the first charge pump 120 is activated irrespective of the detection signal det and outputs the first charge pump signal ccpm, thereby performing a fast charge pumping operation.

An exemplary embodiment in which the charge pump circuit is a two-stage charge pump circuit has been described above. However, the present invention can be applied to charge pump circuits with more stages (for example, four stages).

An exemplary embodiment in which the detector 112 receives the reference voltage Vref has been described above. However, the detector 112 can output the detection signal det by including a circuit for determining whether the voltage level has reached a predetermined voltage, without receiving a special reference voltage Vref.

Accordingly, the charge pump circuit and the charge pumping method according to an exemplary embodiment of the present invention can operate at fast speed.

Although exemplary embodiments of the present invention have been described for illustrative purposes, those skilled in the art will appreciate that various modifications, additions and substitutions are possible, without departing from the scope and spirit of the disclosure.

What is claimed is:

1. A charge pump circuit comprising:
a first charge pump for outputting a first charge pump signal of an intermediate voltage level in response to a command signal;
a detector for outputting a detection signal in response to the command signal when a voltage level of an output node is lower than a designated voltage; and
a second charge pump for charge-pumping the voltage level of the output node to a target charge-pumped voltage level higher than the intermediate voltage level and the designated voltage in response to the detection signal and the first charge pump signal.

2. The charge pump circuit of claim 1, wherein the first charge pump comprises:
at least one charge pump circuit for performing a charge pumping operation in response to the command signal.

3. The charge pump circuit of claim 1, wherein the second charge pump comprises:
a transfer determiner for outputting a second charge pump signal for activating the second charge pump in response to the detection signal and the first charge pump signal;
a precharge controller for deactivating a precharge control signal in response to the second charge pump signal;
a delay unit for outputting a delayed signal by delaying the second charge pump signal for a predetermined time;
a transfer controller for outputting a transfer control signal in response to the second charge pump signal; and
charge pump circuitry for charge-pumping the voltage level of the output node to the target charge-pumped voltage level in response to the precharge control signal, the delayed signal, and the transfer control signal.

4. The charge pump circuit of claim 3, wherein the transfer determiner is a logic AND gate for performing an AND operation on the detection signal and the first charge pump signal.

5. The charge pump circuit of claim 4, wherein the second charge pump signal has the intermediate voltage level.

6. The charge pump circuit of claim 3, wherein the charge pump circuitry comprises:
a first transistor connected between a first power supply voltage and a first node and activated in response to the precharge control signal, the first transistor precharging the first node;
a pump capacitor, connected between the delay unit and the first node, for charge-pumping a voltage level of the first node in response to the delayed signal; and
a second transistor for connecting the first node and the output node in response to the transfer control signal.

7. The charge pump circuit of claim 6, wherein the first power supply voltage is an internal power supply voltage lower than at least one of the target charge-pumped voltage and the designated voltage.

8. A charge pumping method comprising:
generating a first charge pump signal of an intermediate voltage level in response to a command signal;
detecting a voltage level of an output node in response to the command signal simultaneously with the generation of the first charge pump signal, and outputting a detection signal when a voltage level of the output node is lower than a designated voltage; and
charge-pumping the voltage level of the output node in response to the first charge pump signal and the detection signal.

9. The charge pumping method of claim 8, wherein the generating of the first charge pump signal comprises:
performing a charge pumping operation in at least one charge pump stage in response to the command signal.

10. The charge pumping method of claim 8, wherein the charge-pumping of the voltage level of the output node comprises:
outputting a second charge pump signal to control the charge-pumping of the voltage level of the output node in response to the detection signal and the first charge pump signal;
deactivating and outputting a precharge control signal in response to the last charge pump signal;
outputting a delayed signal by delaying the second charge pump signal for a predetermined time;
outputting a transfer control signal in response to the second charge pump signal; and
charge-pumping the voltage level of the output node to a target charge-pumped voltage higher than the intermediate voltage level and the designated voltage in response to the precharge control signal, the delayed signal, and the transfer control signal.

11. The charge pumping method of claim 10, wherein the outputting the second charge pump signal comprises:
performing an AND operation on the detection signal and the first charge pump signal.

12. The charge pumping method of claim 11, wherein the second charge pump signal has the intermediate voltage level.

13. The charge pumping method of claim 10, wherein the charge-pumping of the voltage level of the output node comprises:
precharging a first node in response to the precharge control signal;
charge-pumping a voltage level of the first node in response to the delayed signal; and
charge-sharing between the first node and the output node by connecting the charged-pumped first node to the output node.

14. A charge pump circuit comprising:
a controller for producing a command signal;
a first charge pump for outputting a first charge pump signal of the first voltage level in response to the command signal;
a detector for detecting a voltage level of an output node simultaneously with the outputting of the first charge pump signal, and for outputting a detection signal when a voltage level of the output node is lower than a reference voltage level; and
a second charge pump for charge-pumping the voltage level of the output node to a target charge-pumped voltage level higher than the first voltage level and the reference voltage level in response to the detection signal.

15. The charge pump circuit of claim 14, wherein the controller is directly connected to the detector and to the first charge pump.

16. The charge pump circuit of claim 15, wherein the reference voltage level is externally applied to the detector.

17. The charge pump circuit of claim 15, wherein the reference voltage level is internal to the detector.

18. The charge pump circuit of claim 14, further comprising a third charge pump.

19. The charge pump circuit of claim 14, wherein the second charge pump comprises:
a transfer determiner for outputting a second charge pump signal for activating the second charge pump in response to the detection signal and the first charge pump signal;
a precharge controller for deactivating a precharge control signal in response to the second charge pump signal;
a delay unit for outputting a delayed signal by delaying the second charge pump signal for a predetermined time;
a transfer controller for outputting a transfer control signal in response to the second charge pump signal; and
charge pump circuitry for charge-pumping the voltage level of the output node to the target charge-pumped voltage level in response to the precharge control signal, the delayed signal, and the transfer control signal.

20. The charge pump circuit of claim 19, wherein the charge pump circuit comprises:
a first transistor connected between a first power supply voltage and a first node and activated in response to the precharge control signal, the first transistor precharging the first node;
a pump capacitor, connected between the delay unit and the first node, for charge-pumping a voltage level of the first node in response to the delayed signal; and
a second transistor for connecting the first node and the output node in response to the transfer control signal.
